(19) United States
(12) Patent Application Publication
(10) Pub. No.: US 2019/0092017 A1
(43) Pub. Date: Mar. 28, 2019

(54) HEAD DEVICE AND LIQUID DISCHARGE APPARATUS INCLUDING THE HEAD DEVICE

(71) Applicants: Kunihiro Yamanaka, Kanagawa (JP); Yasuhiko Kachi, Kanagawa (JP)

(72) Inventors: Kunihiro Yamanaka, Kanagawa (JP); Yasuhiko Kachi, Kanagawa (JP)

(73) Assignee: Ricoh Company, Ltd., Tokyo (JP)

(21) Appl. No.: 16/204,267

(22) Filed: Nov. 29, 2018

Related U.S. Application Data
(63) Continuation of application No. 15/377,908, filed on Dec. 13, 2016.

(30) Foreign Application Priority Data
Dec. 18, 2015 (JP) 2015246882
May 18, 2016 (JP) 2016100005
Oct. 14, 2016 (JP) 2016202272

(51) Int. Cl. B41J 2/14; B41J 2/195; B41J 2/175

(52) U.S. Cl. CPC B41J 2/14274; B41J 2/195; B41J 2/175; B41J 2202/12; B41J 2202/08; B41J 2002/14403

(57) ABSTRACT

A head device includes a liquid discharge head, a liquid supply channel, a second temperature-control-liquid channel, and a thermal connector. The liquid discharge head includes a heat generation member and a first temperature-control-liquid channel. The first temperature-control-liquid channel is disposed at a vicinity of the heat generation member. A temperature control liquid flows through the first temperature-control-liquid channel. The liquid supply channel supplies a liquid to the liquid discharge head. The temperature control liquid flows through the second temperature-control-liquid channel. The thermal connector thermally connects the liquid supply channel and the second temperature-control-liquid channel.

### CROSS-REFERENCE TO RELATED APPLICATIONS

This patent application is based on and claims priority pursuant to 35 U.S.C. § 119(a) to Japanese Patent Application Nos. 2015-246882 filed on Dec. 18, 2015, 2016-100005 filed on May 18, 2016, and 2016-202272 filed on Oct. 14, 2016 in the Japan Patent Office, the entire disclosure of each of which is hereby incorporated by reference herein. This patent application is a continuation of co-pending U.S. patent application Ser. No. 15/377,908 (filed on Dec. 13, 2016) titled “HEAD DEVICE AND LIQUID DISCHARGE APPARATUS INCLUDING THE HEAD DEVICE,” which is hereby incorporated by reference.

### BACKGROUND

### Technical Field

Aspects of the present disclosure relate to a head device and a liquid discharge apparatus including the head device.

### Related Art

For a liquid discharge head to discharge liquid, the temperature of the liquid rises with a temperature rise due to heat generation of a heat generation member, such as a drive integrated circuit (driver IC) to drive a pressure generator to discharge the liquid.

### SUMMARY

In an aspect of the present disclosure, there is provided a head device that includes a liquid discharge head, a liquid supply channel, a second temperature-control-liquid channel, and a thermal connector. The liquid discharge head includes a heat generation member and a first temperature-control-liquid channel. The first temperature-control-liquid channel is disposed at a vicinity of the heat generation member. A temperature control liquid flows through the first temperature-control-liquid channel. The liquid supply channel supplies a liquid to the liquid discharge head. The temperature control liquid flows through the second temperature-control-liquid channel. The thermal connector thermally connects the liquid supply channel and the second temperature-control-liquid channel.

In an aspect of the present disclosure, there is provided a head device that includes a liquid discharge head, a temperature-control-liquid channel, a liquid supply channel, and a thermal connector. The liquid discharge head includes a heat generation member. The temperature-control-liquid channel is disposed at a vicinity of the heat generation member. A temperature control liquid to cool the heat generation member flows through the temperature-control-liquid channel. The liquid supply channel supplies a liquid to the liquid discharge head. The thermal connector thermally connects the second temperature-control-liquid channel to the liquid supply channel at an upstream side from the heat generation member in a direction of flow of the temperature control liquid.

In an aspect of the present disclosure, there is provided a liquid discharge apparatus that includes the head device according to any of the above-described aspects, a temperature regulator, and a control-liquid circulation channel. The temperature regulator controls temperature of the temperature control liquid flowing into the head device. The control-liquid circulation channel circulates the temperature control liquid between the head device and the temperature regulator.

### BRIEF DESCRIPTION OF THE SEVERAL VIEWS OF THE DRAWINGS

The aforementioned and other aspects, features, and advantages of the present disclosure would be better understood by reference to the following detailed description when considered in connection with the accompanying drawings, wherein:

FIG. 1 is a perspective view of a head device according to a first embodiment of the present disclosure;

FIG. 2 is an exploded perspective view of a liquid discharge head in the first embodiment;

FIG. 3 is a cross-sectional view of the liquid discharge head of FIG. 2 cut along a direction perpendicular to a nozzle array direction in which nozzles are arrayed in row;

FIG. 4 is a cross-sectional view of a cooling member of the liquid discharge head of FIG. 2;

FIG. 5 is a cross-sectional view of a head body of the liquid discharge head cut along a direction (liquid-chamber longitudinal direction) perpendicular to the nozzle array direction;

FIG. 6 is a cross-sectional view of the liquid discharge head cut along the nozzle array direction (liquid-chamber transverse direction);

FIG. 7 is a perspective view of the head device according to a second embodiment of the present disclosure;

FIG. 8 is an illustration of a section of a route of liquid and temperature control liquid in a liquid discharge apparatus according to a third embodiment of the present disclosure;

FIG. 9 is an illustration of a section of a route of liquid and temperature control liquid in the liquid discharge apparatus according to a fourth embodiment of the present disclosure;

FIG. 10 is a perspective view of the head device according to a fifth embodiment of the present disclosure;

FIG. 11 is an exploded perspective view of the liquid discharge head according to the fifth embodiment;

FIG. 12 is a cross-sectional view of the liquid discharge head of FIG. 11 cut along the direction perpendicular to the nozzle array direction;

FIG. 13 is a cross-sectional view of the cooling member of the liquid discharge head of FIG. 11;

FIG. 14 is a cross-sectional view of an example of the head body cut in the direction (the longitudinal direction of the individual liquid chamber) perpendicular to the nozzle array direction;

FIG. 15 is a perspective view of the head device according to a sixth embodiment of the present disclosure;

FIG. 16 is an illustration of a section of a route of liquid and temperature control liquid in the liquid discharge apparatus according to a seventh embodiment of the present disclosure;

FIG. 17 is an illustration of a section of a route of liquid and temperature control liquid in the liquid discharge apparatus according to an eighth embodiment of the present disclosure;

FIG. 18 is an illustration of the liquid discharge apparatus according to an embodiment of the present disclosure;

FIG. 19 is a plan view of a head unit of the liquid discharge apparatus of FIG. 18 according to an embodiment of the present disclosure; and

FIG. 20 is a block diagram of a liquid circulation system of the liquid discharge apparatus of FIG. 18 according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

Referring now to the drawings, wherein like reference numerals designate identical or corresponding parts throughout the several views, embodiments of the present disclosure are described below.

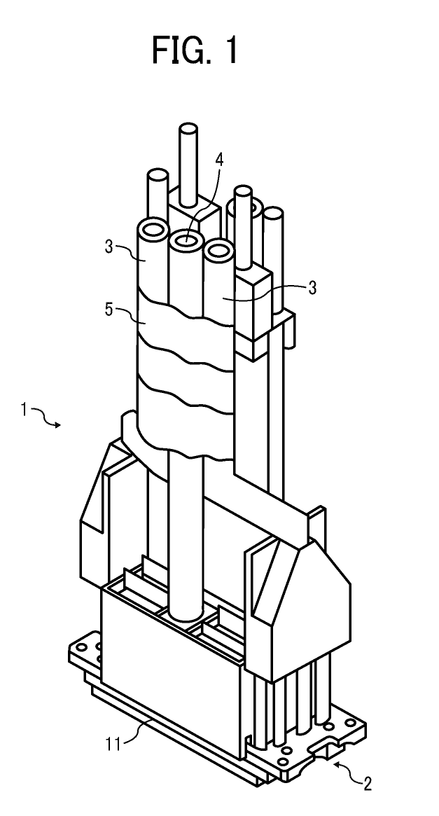

A first embodiment of the present disclosure is described with reference to FIG. 1. FIG. 1 is a perspective view of a head device of the first embodiment of the present disclosure.

A head device 1 includes a liquid discharge head 2, liquid supply channels 3, a second temperature-control-liquid channel 4, and a thermal connector 5. The liquid supply channel 3 supplies liquid to be discharged, to the liquid discharge head 2. Temperature control liquid flows through the second temperature-control-liquid channel 4. The thermal connector 5 thermally connects the liquid supply channel 3 and the second temperature-control-liquid channel 4.

In the present embodiment, the liquid supply channel 3 is a conduit made of, for example, stainless steel (SUS), and the second temperature-control-liquid channel 4 is a conduit of, for example, aluminum. The thermal connector 5 is, for example, a thermal conductive tape.

In a state in which the second temperature-control-liquid channel 4 is interposed between the liquid supply channels 3 in contact with the liquid supply channels 3, the second temperature-control-liquid channel 4 and the liquid supply channels 3 are collectively secured by the thermal connector 5. Thus, the liquid supply channels 3 and the second temperature-control-liquid channel 4 are thermally connected to each other.

In the second temperature-control-liquid channel 4, temperature control liquid, such as water, flows. The temperature of the temperature control liquid is controlled by an external temperature regulator, such as a chiller.

Accordingly, the temperature of the liquid supplied to the liquid discharge head 2 can be controlled by the temperature of the temperature control liquid flown to the second temperature-control-liquid channel 4.

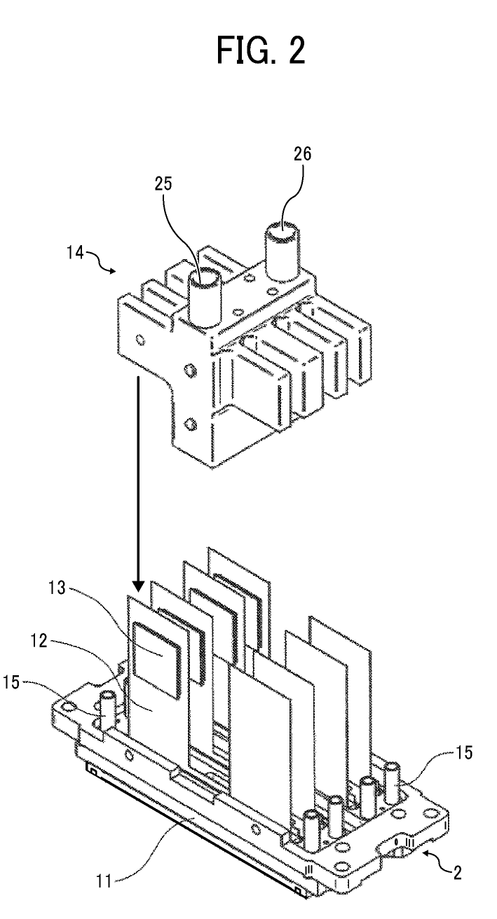

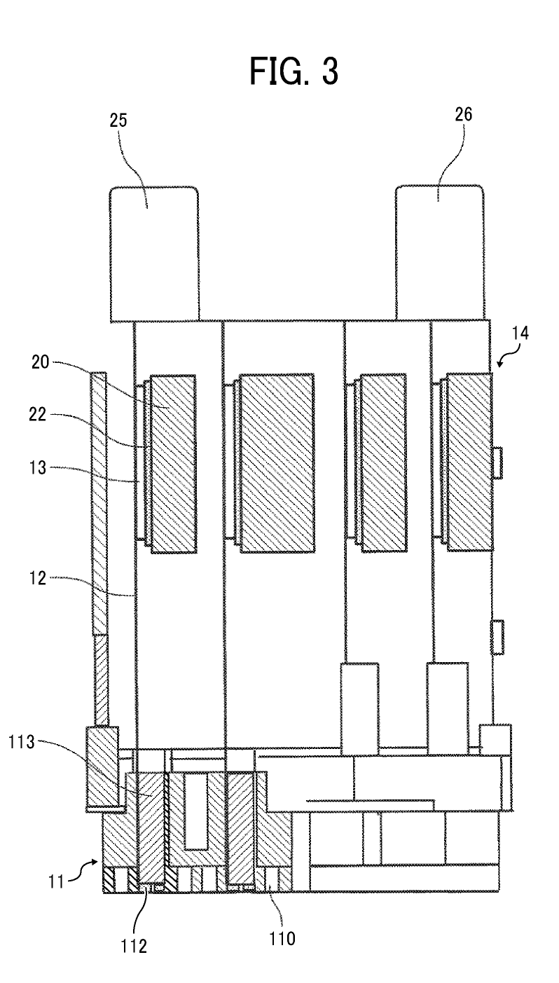

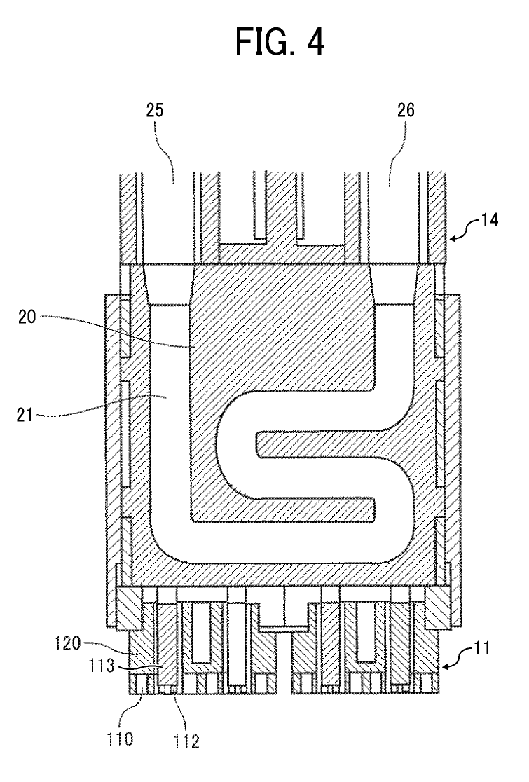

The liquid discharge head according to the first embodiment of the present disclosure is further described with reference to FIGS. 2 to 4. FIG. 2 is an exploded perspective view of the liquid discharge head according to the first embodiment. FIG. 3 is a cross-sectional view of the liquid discharge head of FIG. 2 cut along a direction perpendicular to a nozzle array direction in which nozzles are arrayed in row. FIG. 4 is a cross-sectional view of a cooling member of the liquid discharge head of FIG. 2.

Liquid is supplied from the liquid supply channels 3 to supply ports 15 of a head body 11.

Driver integrated circuits (drive ICs) 13 to drive the pressure generators are mounted on flexible wiring members 12, such as flexible printed circuits (FPCs), connected to the pressure generators of the head body 11. The driver IC 13 is a heat generation member to generate heat. Note that the term “heat generation member” used herein does not mean a member for heat generation but a member (device) in which heat is generated by, e.g., driving of the liquid discharge head. Therefore, the heat generation member in the present disclosure is not limited to the driver IC.

A cooling member 14 is disposed at the vicinity of the driver ICs 13 to cool the driver ICs 13 and the vicinity.

The cooling member 14 includes a first temperature-control-liquid channel 21, through which the temperature control liquid flows, in a heat receiving part 20. In the first temperature-control-liquid channel 21, the temperature control liquid, such as water, flows. The temperature of the temperature control liquid is controlled by the external temperature regulator, such as a chiller. Note that the cooling member 14 has ports 25 and 26 of the first temperature-control-liquid channel 221.

The heat receiving part 20 of the cooling member 14 is thermally coupled to a surface of the driver IC 13 via a heat transmission sheet 22. In the heat receiving part 20, the first temperature-control-liquid channel 21, through which the temperature control liquid flows, is disposed adjacent to the driver IC 13.

With such a configuration, the temperature control liquid flows through the first temperature-control-liquid channel 21 of the cooling member 14. Accordingly, the driver ICs 13 are cooled to reduce heat generation, thus reducing temperature rise in liquid due to heat radiation of the driver ICs 13.

As described above, the driver ICs are cooled with another temperature control liquid to reduce heat generation. Accordingly, the driver ICs can be cooled at high efficiency without degradation of liquid. In addition, since the liquid supply channels and the temperature-control-liquid channel are thermally connected with the thermal connector, temperature-controlled liquid can be supplied to the head body without circulation of liquid.

Accordingly, while reducing the heat generation of the driver ICs, the temperature of liquid can be controlled with a simple configuration.

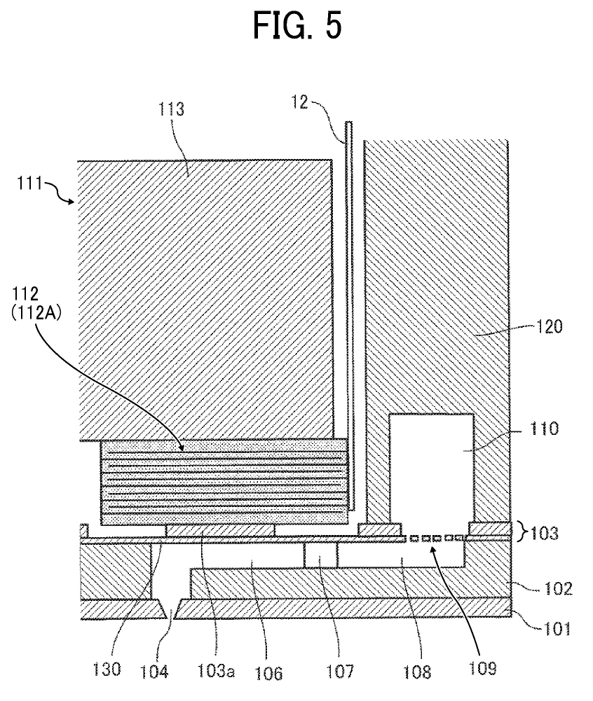

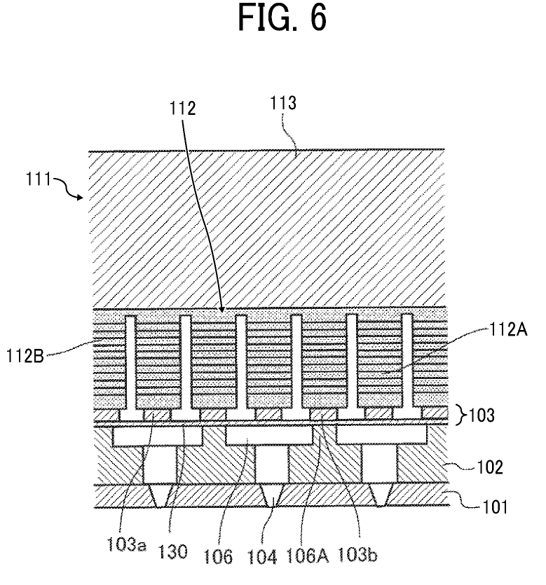

Here, an example of the head body of the liquid discharge head is described with reference to FIGS. 5 and 6. FIG. 5 is a cross-sectional view of the head body of the liquid discharge head cut along a direction (liquid-chamber longitudinal direction) perpendicular to the nozzle array direction. FIG. 6 is a cross-sectional view of the liquid discharge head cut along the nozzle array direction (liquid-chamber transverse direction).

In the head body 11, the nozzle plate 101, the channel plate 102, and the diaphragm member 103 are bonded together. The head body 11 includes piezoelectric actuators 111 as pressure generators to displace the diaphragm member 103 and a frame member 120 (also referred to as common-liquid-chamber substrate 120) serving as a frame and a common-liquid-chamber substrate.

Thus, individual liquid chambers (also referred to as pressure chambers or pressurizing chambers) 106 communicated with a plurality of nozzles 104 to discharge liquid, the fluid restrictors 107 to supply liquid to the individual liquid chambers 106, and liquid introduction portions 108 communicated with the fluid restrictors 107. Adjacent ones of the individual liquid chambers 106 are separated with a partition 106A.

Liquid is supplied from a common liquid chamber 110 of the frame member 120 to each of the individual liquid chambers 106 through a filter 109, the liquid introduction portion 108, and the fluid restrictor 107. The filters 109 are formed in the diaphragm member 103.

The piezoelectric actuator 111 is disposed opposite the individual liquid chamber 106 with a deformable vibration portion 130 interposed between the piezoelectric actuator 111 and the individual liquid chamber 106. The vibration portion 130 constitutes part of a wall of the individual liquid chamber 106 of the diaphragm member 103.

The piezoelectric actuator 111 includes a plurality of laminated piezoelectric members 112 bonded on a base 113. The piezoelectric member 112 is groove-processed by half cut dicing. Pillar-shaped piezoelectric elements (piezoelectric pillars) 112A and support pillars 112B are disposed at predetermined distances in a comb shape. Driving signals are applied to the piezoelectric elements 112A.

The piezoelectric elements 112A are bonded to island-shaped projections 103a in the vibration portions 130 of the diaphragm member 103. The support pillars 112B are bonded to projections 103b of the diaphragm member 103.

The piezoelectric member 112 includes piezoelectric layers and internal electrodes alternately laminated one on another. The internal electrodes are led out to end faces to form external electrodes. The flexible wiring member 12, such as a flexible printed circuit (FPC), is connected to external electrodes of the piezoelectric element 112A to apply a drive waveform to the piezoelectric element 112A.

The frame member 120 includes the common liquid chamber 110 to which liquid is supplied from the head tanks and liquid cartridges.

In the liquid discharge head 2 having the head body 11, for example, when the voltage applied to the piezoelectric element 112A is lowered from a reference potential, the piezoelectric element 112A contracts. As a result, the vibration portion 130 of the diaphragm member 103 moves downward and the volume of the individual liquid chamber 106 increases, thus causing liquid to flow into the individual liquid chamber 106.

When the voltage applied to the piezoelectric element 112A is raised, the piezoelectric element 112A expands in the direction of lamination. The vibration portion 130 of the diaphragm member 103 deforms in a direction toward the nozzle 104 and contracts the volume of the individual liquid chamber 106. Thus, liquid in the individual liquid chamber 106 is pressurized and discharged (jetted) from the nozzle 104.

When the voltage applied to the piezoelectric element 112A is returned to the reference potential, the vibration portion 130 of the diaphragm member 103 is returned to the initial position and the individual liquid chamber 106 expands to generate a negative pressure. Accordingly, liquid is replenished from the common liquid chamber 110 to the individual liquid chamber 106 through the fluid restrictor 107. After the vibration of a meniscus surface of the nozzle 104 decays to a stable state, the liquid discharge head 2 shifts to an operation for the next droplet discharge.

Note that the driving method of the liquid discharge head is not limited to the above-described example (pull-push discharge). For example, pull discharge or push discharge may be performed in response to the way to apply the drive waveform.

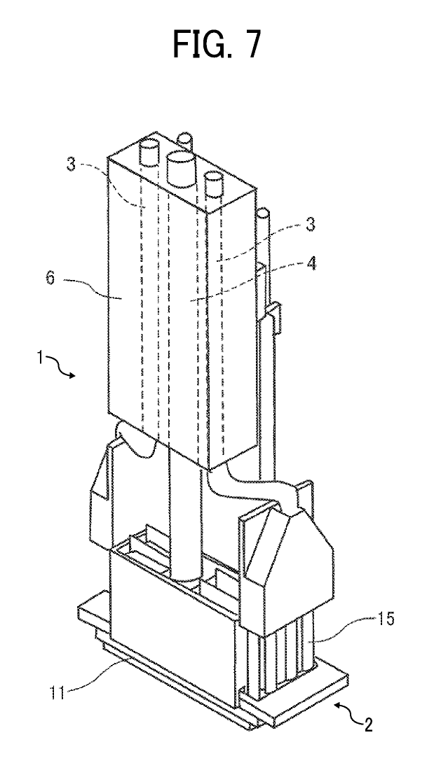

Next, a second embodiment of the present disclosure is described with reference to FIG. 7. FIG. 7 is a perspective view of a head device of the second embodiment of the present disclosure.

In the second embodiment, the head device 1 includes a heat exchanger 6 molded with the liquid supply channel 3 and the second temperature-control-liquid channel 4 as a single unit. The heat exchanger 6 also acts a thermal connector to thermally connect the liquid supply channel 3 and the second temperature-control-liquid channel 4. The heat exchanger 6 is made of a block of a material, such as aluminum, having a high degree of thermal conductivity.

In the present embodiment, the second temperature-control-liquid channel 4 is made of an aluminum block having a high degree of thermal conductivity. The liquid supply channel 3 is a tube, such as a SUS tube, made of a material having a high chemical resistance (liquid resistance) resistant. The tube, e.g., the SUS tube as the liquid supply channel 3 is embedded in the aluminum block (the heat exchanger 6).

Such a configuration allows effective heat exchange between liquid flowing through the liquid supply channel 3 and the temperature control liquid flowing through the second temperature-control-liquid channel 4, thus allowing effective temperature control of the liquid flowing through the liquid supply channel 3.

The liquid supply channel 3 is made of a material having a high liquid resistance and the temperature-control-liquid channel 4 is made of a material of a high heat conductivity. Such a configuration can enhance the heat exchange rate while securing the liquid contact properly.

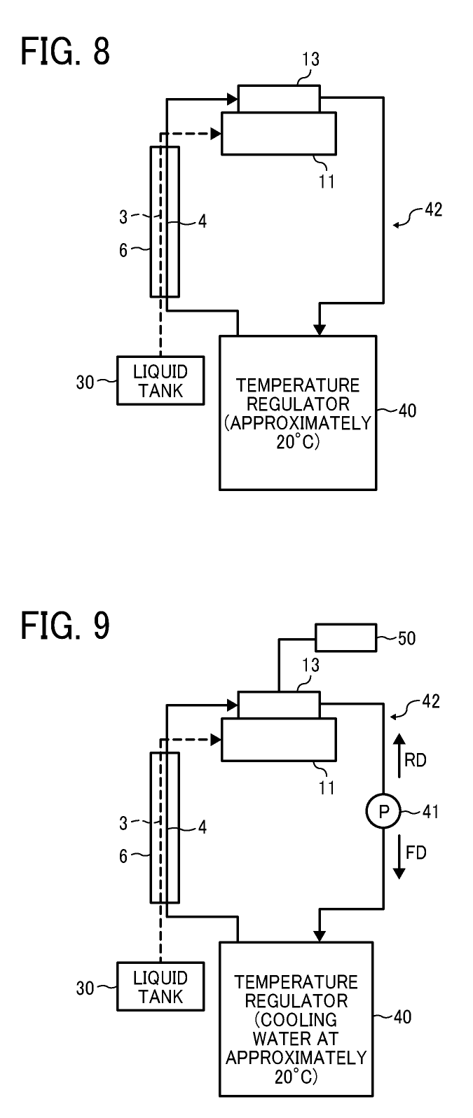

Next, a third embodiment of the present disclosure is described with reference to FIG. 8. FIG. 8 is an illustration of a section of a route of liquid and temperature control liquid in a liquid discharge apparatus 2000 according to the third embodiment.

The liquid discharge apparatus 2000 includes a liquid tank 30 to store liquid. Liquid is supplied from the liquid tank 30 to the head body 11 through the liquid supply channel 3 passing inside the heat exchanger 6. Note that the configuration of the first embodiment may be employed instead of the heat exchanger 6.

The temperature regulator 40 is a temperature regulation unit, such as a chiller, to control the temperature of temperature control liquid. The temperature control liquid is circulated through a channel in which the temperature control liquid flows from the temperature regulator 40 to the driver IC 13 through the second temperature-control-liquid channel 4 passing inside the heat exchanger 6 and returns via the first temperature-control-liquid channel 21 of the cooling member 14. In other words, the liquid discharge apparatus 2000 includes a control-liquid circulation channel 42 connecting from the temperature regulator 40 via the second temperature-control-liquid channel 4 in the heat exchanger 6 and the first temperature-control-liquid channel 21 in the cooling member 14 to the temperature regulator 40.

Such a configuration allows cooling of the driver IC 13 and temperature control of liquid to be supplied to the channel in the head body 11, thus reducing a temperature rise in liquid and securing stable discharge properties.

Next, a fourth embodiment of the present disclosure is described with reference to FIG. 9. FIG. 9 is an illustration of a section of a route of liquid and temperature control liquid in a liquid discharge apparatus 2000 according to the fourth embodiment.

In the present embodiment, a warming mode and a cooling mode can be switched. In the present embodiment, a pump 41 is disposed between the temperature regulator 40 and the first temperature-control-liquid channel 21 of the cooling member 14. The pump 41 acts as a switching unit to switch the direction of flow of temperature control liquid between the forward direction (indicated by arrow FD in FIG. 9) and the reverse direction (indicated by arrow RD in FIG. 9).

In the warming mode, the temperature control liquid controlled in temperature by the temperature regulator 40 is flown in the reverse direction RD with the pump 41 and is warmed by heat generation of the driver IC 13 while flowing through the first temperature-control-liquid channel 21. The temperature control liquid warmed in the first temperature-control-liquid channel 21 flows into the heat exchanger 6, and liquid flowing through the liquid supply channel 3 is warmed by the heat exchanger 6.

By contrast, in the cooling mode, the temperature control liquid controlled in temperature with the temperature regulator 40 is flown in the forward direction FD with the pump 41 and flows through the second temperature-control-liquid channel 4. Thus, liquid flowing through the liquid supply channel 3 is cooled by the heat exchanger 6.

With such a configuration, the warming mode to warm liquid and the cooling mode to cool liquid according to the environmental temperature can be switched, thus allowing control of the temperature of liquid in a broad range of environmental temperatures.

The warming mode is used to activate the liquid discharge apparatus 2000 under an environment in a range of, for example, low temperatures (from 10° C. to 15° C.).

In the warming mode, a controller 50 controls the driver ICs 13 to drive the liquid discharge head without discharging liquid. Accordingly, the temperature control liquid is warmed by heat generated from the driver ICs 13, thus warming the liquid to be supplied to the liquid discharge head.

To sufficiently absorb heat of the driver IC 13 into the temperature control liquid, the flow speed is set lower when the temperature control liquid is flown in the reverse direction RD in the warming mode than when the temperature control liquid is flown in the forward direction FD in the cooling mode.

With such a configuration, in the cooling mode, the driver ICs 13 can be promptly cooled with a large amount of liquid flow. In the warming mode, the temperature control liquid is heated with the driver IC 13 over time to increase the temperature of the temperature control liquid. Thus, liquid flowing through the liquid supply channel 3 can be effectively heated through the heat exchanger 6.

Such a configuration can warm the temperature control liquid without installing another heating unit.

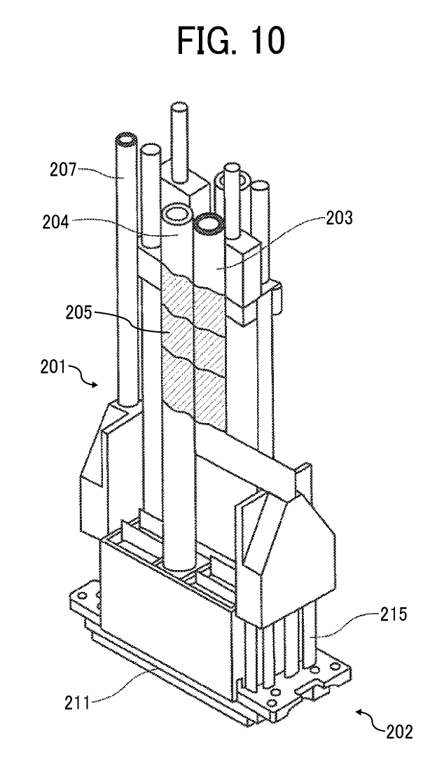

Next, a fifth embodiment of the present disclosure is described with reference to FIG. 10. FIG. 10 is a perspective view of a head device of the fifth embodiment of the present disclosure.

A head device 201 includes a liquid discharge head 202, a liquid supply channel 203, a second temperature-control-liquid channel 204, and a thermal connector 205. The liquid supply channel 203 supplies liquid to be discharged, to the liquid discharge head 202. Temperature control liquid flows through the second temperature-control-liquid channel 204. The thermal connector 5 thermally connects the liquid supply channel 203 and the second temperature-control-liquid channel 204.

In the present embodiment, the liquid supply channel 203 is a conduit made of, for example, stainless steel (SUS), and the second temperature-control-liquid channel 204 is a conduit of, for example, aluminum. The thermal connector 205 is, for example, a thermal conductive tape.

The liquid supply channel 203 and the second temperature-control-liquid channel 204 are integrally secured by the thermal connector 205 in a state in which the second temperature-control-liquid channel 204 is disposed in contact with the liquid supply channel 203 from one side of the liquid supply channel 203. Thus, the liquid supply channel 203 and the second temperature-control-liquid channel 204 are thermally coupled.

In the second temperature-control-liquid channel 204, the temperature control liquid, such as water, flows. The temperature of the temperature control liquid is controlled by the external temperature regulator, such as a chiller.

Accordingly, the temperature of the liquid supplied to the liquid discharge head 202 can be controlled by the temperature of the temperature control liquid flown to the second temperature-control-liquid channel 204.

The head device 201 according to the present embodiment differs from the head device 1 of the above-described first embodiment in that the head device 201 includes a liquid circulation channel 207 to circulate liquid delivered from the liquid discharge head 202.

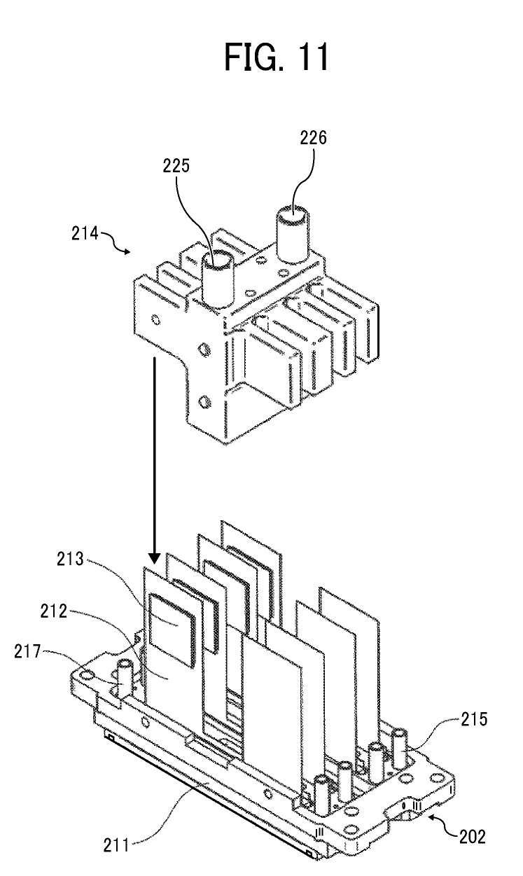

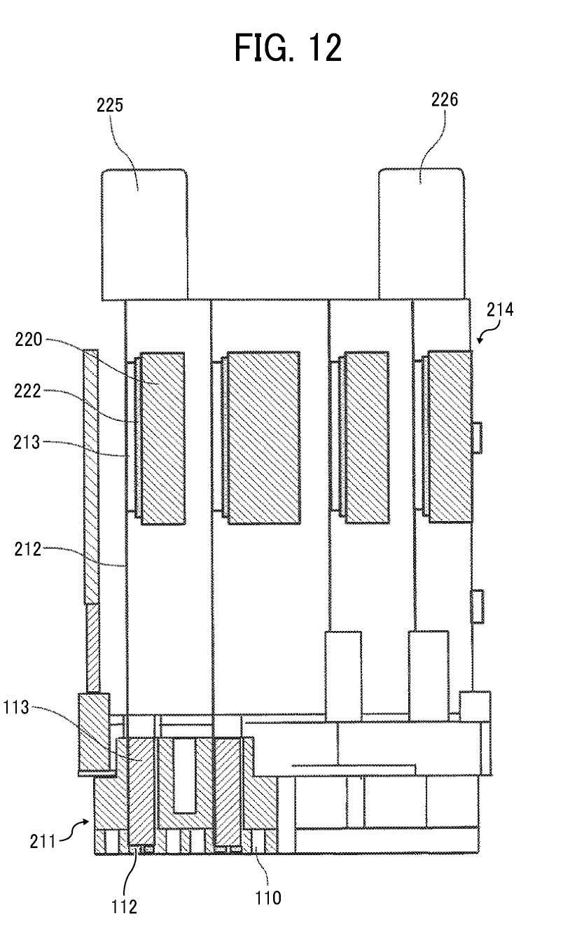

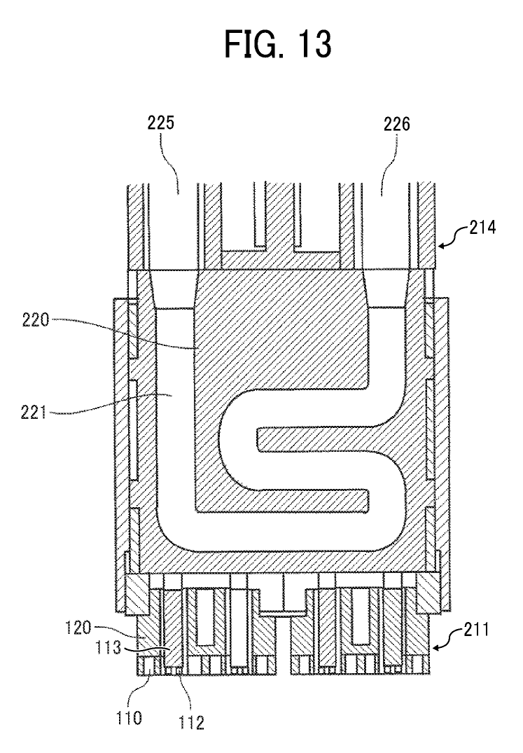

The liquid discharge head according to the fifth embodiment of the present disclosure is further described with reference to FIGS. 11 to 13. FIG. 11 is an exploded perspective view of the liquid discharge head according to the fifth embodiment. FIG. 12 is a cross-sectional view of the liquid discharge head of FIG. 11 cut along the direction perpendicular to the nozzle array direction in which the nozzles are arrayed in row. FIG. 13 is a cross-sectional view of a cooling member of the liquid discharge head of FIG. 11.

Liquid is supplied from the liquid supply channel 203 to supply ports 215 of a head body 211 and delivered from delivery ports (circulation ports) 217 of the head body 211 to the liquid circulation channel 207.

Driver ICs (drive ICs) 213 to drive the pressure generators are mounted on flexible wiring members 212, such as flexible printed circuits (FPCs), connected to the pressure generators of the head body 211. The driver IC 213 is a heat generation member to generate heat. Note that, as described above, the term “heat generation member” used herein means a member (device) in which heat is generated by, e.g., driving of the liquid discharge head.

A cooling member 214 is disposed at the vicinity of the driver ICs 213 to cool the driver ICs 213 and the vicinity.

The cooling member 14 includes a first temperature-control-liquid channel 221, through which the temperature control liquid flows, in a heat receiving part 220. In the first temperature-control-liquid channel 221, the temperature control liquid, such as water, flows. The temperature of the temperature control liquid is controlled by the external temperature regulator, such as a chiller. Note that the cooling member 14 has ports 225 and 226 of the first temperature-control-liquid channel 221.

The heat receiving part 220 of the cooling member 214 is thermally coupled to a surface of the driver IC 213 via a heat transmission sheet 222. In the heat receiving part 220, the first temperature-control-liquid channel 221, through which the temperature control liquid flows, is disposed adjacent to the driver IC 213.

With such a configuration, the temperature control liquid flows through the first temperature-control-liquid channel 221 of the cooling member 214. Accordingly, the driver ICs 213 are cooled to reduce heat generation, thus reducing temperature rise in liquid due to heat radiation of the driver ICs 213.

As described above, the driver ICs are cooled with another temperature control liquid to reduce heat generation. Accordingly, the driver ICs can be cooled at high efficiency without degradation of liquid. In addition, since the liquid supply channels and the temperature-control-liquid channel are thermally connected with the thermal connector, temperature-controlled liquid can be supplied to the head body without circulation of liquid.

Accordingly, while reducing the heat generation of the driver ICs, the temperature of liquid can be controlled with a simple configuration.

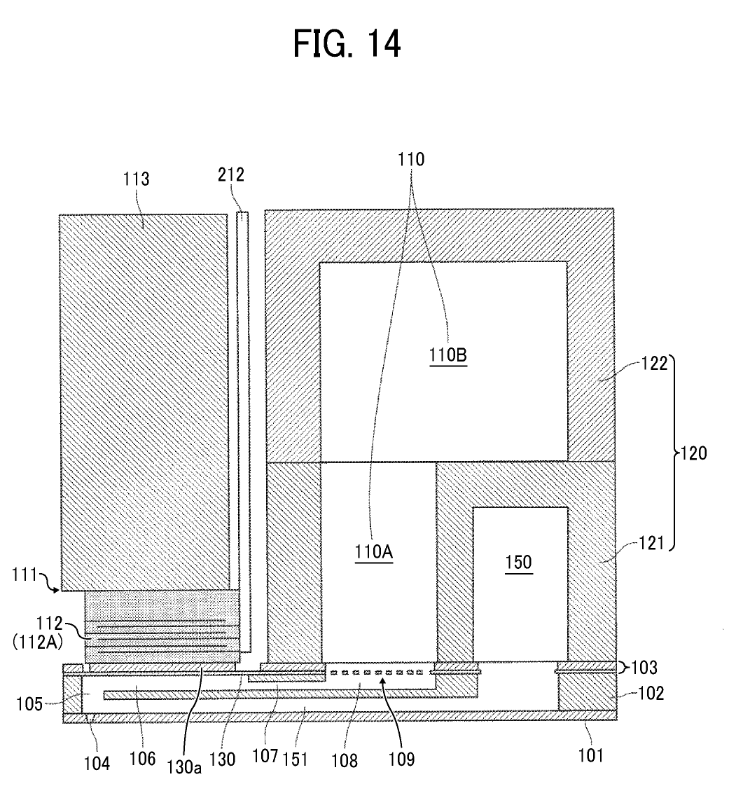

Here, an example of the head body of the liquid discharge head is described with reference to FIG. 14. FIG. 14 is a cross-sectional view of an example of the head body cut in the direction (the longitudinal direction of the individual liquid chamber) perpendicular to the nozzle array direction. Note that the same reference codes are assigned to the portions corresponding to the portions of FIG. 5.

In the head body 211, a nozzle plate 101, a channel plate 102, and a diaphragm member 103 as a wall member are laminated one on another and bonded to each other. The head body 211 further includes piezoelectric actuators 111 to displace vibration portions (diaphragms) 130 of the diaphragm member 103 and the common-liquid-chamber substrate 120 (also referred to as the frame member 120) serving as a frame and a common-liquid-chamber substrate.

The nozzle plate 101 includes a plurality of nozzles 104 to discharge liquid.

The channel plate 102 includes through-holes and grooves as nozzle communication passages 105 communicated with the nozzles 104, individual liquid chambers 106 communicated with the nozzle communication passages 105, supply-side fluid restrictors 107 communicated with the individual liquid chambers 106, and liquid introduction portions 108 communicated with the supply-side fluid restrictors 107. The nozzle communication passage 105 is a flow channel continuous and communicated with each of the nozzle 104 and the individual liquid chamber 106.

The channel plate 102 further includes grooves or through holes as delivery channels 151 communicated with neighboring portions of the nozzle communication passages 105 close to the nozzles 104.

In the present embodiment, the channel plate 102 is a single sheet of plate member. However, in some embodiments, for example, a plurality of thin plates including grooves or through holes may be bonded together to form the fluid restrictors 107 and the delivery channels 151 to form a complicated channel shape.

The diaphragm member 103 includes the deformable vibration portions 130 constituting wall faces of the individual liquid chambers 106 of the channel plate 102. In the present embodiment, the diaphragm member 103 has a two-layer structure including a first layer including thin portions and facing the channel plate 102 and a second layer including thick portions. The first layer includes the deformable vibration portions 130 at positions corresponding to the individual liquid chambers 106. Note that the diaphragm member 103 is not limited to the two-layer structure and the number of layers may be any other suitable number.

The piezoelectric actuators 111 including electromechanical transducer elements as driving devices (actuator devices or pressure generators) to deform the vibration portions 130 of the diaphragm member 103 are disposed at a first side of the diaphragm member 103 opposite a second side facing the individual liquid chambers 106.

The piezoelectric actuator 111 includes piezoelectric members 112 bonded on a base 113. The piezoelectric members 112 are groove-processed by half cut dicing so that each piezoelectric member 112 includes a desired number of pillar-shaped piezoelectric elements (piezoelectric pillars) 112A and support pillars 112B that are arranged in certain intervals to have a comb shape.

The piezoelectric elements 112A are bonded to projections 103a being island-shaped thick portions in the vibration portions 130 of the diaphragm member 103.

The piezoelectric member 112 includes piezoelectric layers and internal electrodes alternately laminated. The internal electrodes are lead out to an end face of the piezoelectric member 112 to form external electrodes. The external electrodes are connected to a flexible wiring member 212.

The common-liquid-chamber substrate 120 includes a supply-side common liquid chamber 110 and a delivery-side common liquid chamber 150. The supply-side common liquid chamber 110 is communicated with the supply ports 215. The delivery-side common liquid chamber 150 is communicated with the delivery ports 217.

Note that, in the present embodiment, the common-liquid-chamber substrate 120 includes a first common-liquid-chamber substrate 121 and a second common-liquid-chamber substrate 122. The first common-liquid-chamber substrate 121 is bonded to the diaphragm member 103. The second common-liquid-chamber substrate 122 is laminated on and bonded to the first common-liquid-chamber substrate 121.

The first common-liquid-chamber substrate 121 includes a downstream common liquid chamber 110A and the delivery-side common liquid chamber 150. The downstream common liquid chamber 110A is part of the supply-side common liquid chamber 110 communicated with the liquid introduction portion 108. The delivery-side common liquid chamber 150 is communicated with the delivery channel 151. The second common-liquid-chamber substrate 122 includes an upstream common liquid chamber 110B that is a remaining portion of the supply-side common liquid chamber 110. Note that a filter 109 formed in the first layer of the diaphragm member 103 is disposed between the downstream common liquid chamber 110A and the liquid introduction portion 108.

The downstream common liquid chamber 110A constituting part of the supply-side common liquid chamber 110 and the delivery-side common liquid chamber 150 are arranged side by side in the direction perpendicular to the nozzle array direction. The delivery-side common liquid chamber 150 is disposed at a position at which the delivery-side common liquid chamber 150 is projected in the supply-side common liquid chamber 110.

The channel plate 102 includes the delivery channels 151 formed along a surface direction of the channel plate 102 and communicated with the individual liquid chambers 106 via the nozzle communication passages 105. The delivery channels 151 as individual circulation channels are communicated with the delivery-side common liquid chamber 150.

In the liquid discharge head thus configured, for example, when a voltage lower than a reference potential (intermediate potential) is applied to the piezoelectric element 112A, the piezoelectric element 112A contracts. Accordingly, the vibration portion 130 of the diaphragm member 103 is pulled to increase the volume of the individual liquid chamber 106, thus causing liquid to flow into the individual liquid chamber 106.

When the voltage applied to the piezoelectric element 112A is raised, the piezoelectric element 112A extends in a direction of lamination. Accordingly, the vibration portion 130 of the diaphragm member 103 deforms in a direction toward the nozzle 104 and the volume of the individual liquid chamber 106 reduces. Thus, liquid in the individual liquid chamber 106 is pressurized and discharged from the nozzle 104.

Liquid not discharged from the nozzles 104 passes the nozzles 104, and are delivered from the delivery channels 151 to the delivery-side common liquid chamber 150 and supplied from the delivery-side common liquid chamber 150 to the supply-side common liquid chamber 110 again through an external circulation route.

Next, a sixth embodiment of the present disclosure is described with reference to FIG. 15. FIG. 15 is a perspective view of a head device of the sixth embodiment of the present disclosure.

In the sixth embodiment, the head device 201 includes a heat exchanger 206 integrally molded with the liquid supply channel 203 and the second temperature-control-liquid channel 204 as a single unit. The heat exchanger 206 also acts a thermal connector to thermally connect the liquid supply channel 203 and the second temperature-control-liquid channel 204. The heat exchanger 206 is made of a block of a material, such as aluminum, having a high degree of thermal conductivity.

In the present embodiment, the second temperature-control-liquid channel 204 is made of an aluminum block having a high degree of thermal conductivity. The liquid supply channel 203 is a tube, such as a SUS tube, made of a material having a high chemical resistance (liquid resistance) resistant. The tube, e.g., the SUS tube as the liquid supply channel 203 is embedded in the aluminum block (the heat exchanger 206).

Such a configuration allows effective heat exchange between liquid flowing through the liquid supply channel 203 and the temperature control liquid flowing through the second temperature-control-liquid channel 204, thus allowing effective temperature control of the liquid flowing through the liquid supply channel 203.

The liquid supply channel 203 is made of a material having a high liquid resistance and the temperature-control-liquid channel 204 is made of a material of a high heat conductivity. Such a configuration can enhance the heat exchange rate while securing the liquid contact properly.

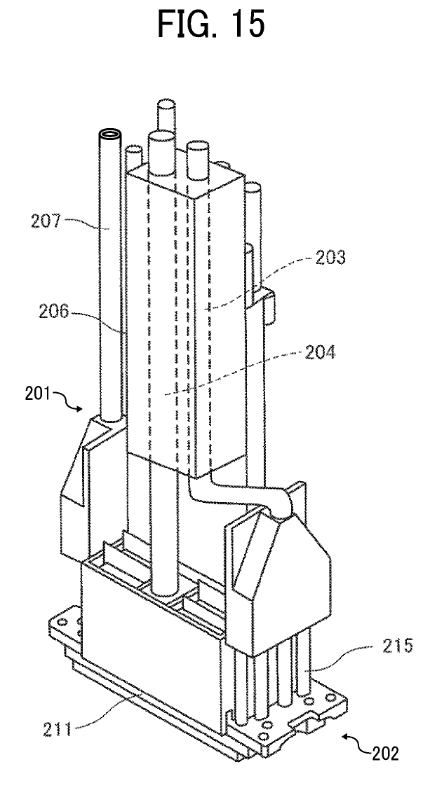

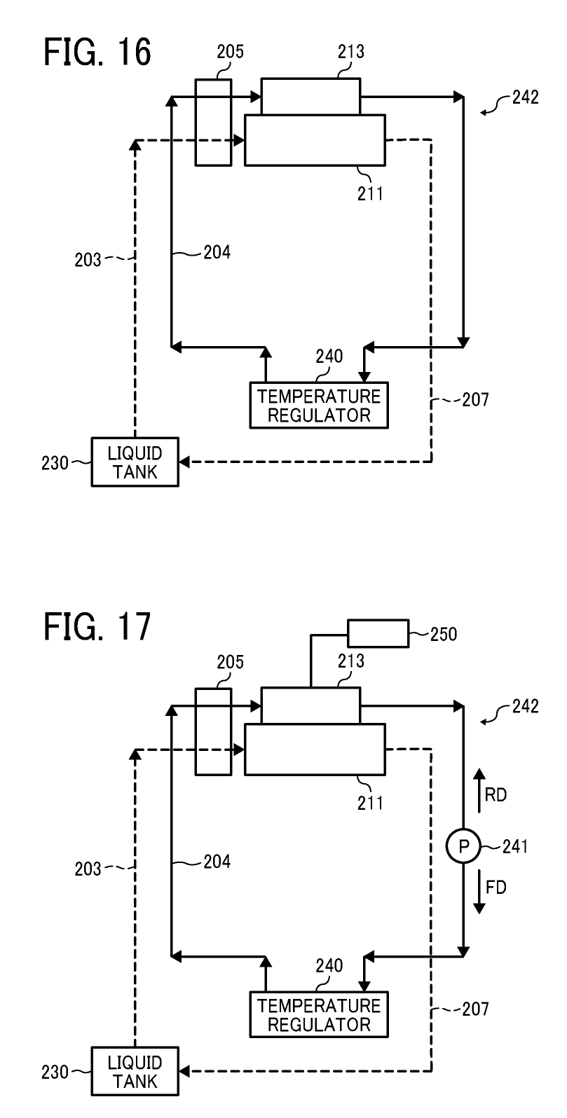

Next, a seventh embodiment of the present disclosure is described with reference to FIG. 16. FIG. 16 is an illustration of a section of a route of liquid and temperature control liquid in the liquid discharge apparatus 2000 according to the seventh embodiment.

The liquid discharge apparatus 2000 includes a liquid tank 230 to store liquid. Liquid is supplied from the liquid tank 230 to the head body 211 through the liquid supply channel 203 passing inside a thermal connecting portion formed with the thermal connector 205. An unused portion of the liquid supplied to the head body 211 is returned to the liquid tank 30 via the liquid circulation channel 207. Note that the configuration of the heat exchanger 206 may be employed instead of the thermal connector 205.

A temperature regulator 240 is a temperature regulation unit, such as a chiller, to control the temperature of temperature control liquid. The temperature control liquid is circulated through a channel in which the temperature control liquid flows from the temperature regulator 240 to the driver IC 213 through the second temperature-control-liquid channel 204 passing inside the heat exchanger 206 and returns via the first temperature-control-liquid channel 221 of the cooling member 214. In other words, the liquid discharge apparatus 2000 includes a control-liquid circulation channel 242 connecting from the temperature regulator 240 via the second temperature-control-liquid channel 204 in the heat exchanger 206 and the first temperature-control-liquid channel 221 in the cooling member 214 to the temperature regulator 240.

Such a configuration allows cooling of the driver IC 213 and temperature control of liquid to be supplied to the channel in the head body 211, thus reducing a temperature rise in liquid and securing stable discharge properties.

In the present embodiment, the flow amount of circulation of the temperature control liquid is, for example, 4 ml/s, and the flow amount of circulation of the liquid is 0.4 ml/s. The flow amount of circulation of the temperature control liquid is greater than the flow amount of circulation of the liquid to be supplied to the liquid discharge head. The flow amount of the temperature control liquid is set to a value to control the temperature of the temperature control liquid. Regarding the flow amount of circulation of the liquid to be supplied to the liquid discharge head, for a circulation-type head, since the pressure loss of each nozzle is proportional to the flow amount of circulation. Accordingly, as the flow amount of circulation is greater, discharge variations between the nozzles increase, thus hampering an increase of the flow amount of circulation. Hence, the flow amount of circulation of the liquid to be supplied to the liquid discharge head is set to a flow amount at which variations between discharged droplets can be reduced.

As described in the present embodiment, the liquid supply channel 203 and the second temperature-control-liquid channel 204 are thermally connected to each other at an immediately upstream side of the cooling member 214 of the driver IC 13 in the liquid discharge head 202. Since the liquid supply channel 203 connected to the liquid discharge head 202 is thermally bonded to the second temperature-control-liquid channel 204, the temperature of the liquid to be supplied to the liquid discharge head 202 can be controlled to a temperature close to the temperature of the temperature control liquid.

Since the temperature regulator 240, such as a chiller or a radiator, is not disposed adjacent to the liquid discharge head 202, the temperature of the liquid changes in the course to the liquid discharge head 202 even if the temperature of the liquid is controlled with the temperature regulator 240. However, in the present embodiment, the thermal bonding is adjacent to the liquid discharge head 202, thus allowing more accurate control of the temperature of the liquid.

Next, an eighth embodiment of the present disclosure is described with reference to FIG. 17. FIG. 17 is an illustration of a section of a route of liquid and temperature control liquid in the liquid discharge apparatus 2000 according to the eighth embodiment.

In the present embodiment, a warming mode and a cooling mode can be switched. In the present embodiment, a pump 241 is disposed between the temperature regulator 240 and the first temperature-control-liquid channel 221 of the cooling member 214, to switch the direction of flow of temperature control liquid between the forward direction (indicated by arrow FD in FIG. 17) and the reverse direction (indicated by arrow RD in FIG. 17).

In the warming mode, the temperature control liquid controlled in temperature by the temperature regulator 240 is flown in the reverse direction RD with the pump 241 and is warmed by heat generation of the driver IC 213 while flowing through the first temperature-control-liquid channel 221. The temperature control liquid warmed in the first temperature-control-liquid channel 221 flows into the heat exchanger 206, and liquid flowing through the liquid supply channel 203 is warmed by the heat exchanger 206.

By contrast, in the cooling mode, the temperature control liquid controlled in temperature with the temperature regulator 240 is flown in the forward direction FD with the pump 241 and flows through the second temperature-control-liquid channel 204. Thus liquid flowing through the liquid supply channel 203 is cooled by the heat exchanger 206.

With such a configuration, the warming mode to warm liquid and the cooling mode to cool liquid according to the environmental temperature can be switched, thus allowing control of the temperature of liquid in a broad range of environmental temperatures.

The warming mode is used to activate the liquid discharge apparatus 2000 under an environment in a range of, for example, low temperatures (from 10° C. to 15° C.).

In the warming mode, a controller 250 controls the driver ICs 213 to drive the liquid discharge head without discharging liquid. Accordingly, the temperature control liquid is warmed by heat generated from the driver ICs 213, thus warming the liquid to be supplied to the liquid discharge head.

To sufficiently absorb heat of the driver IC 213 into the temperature control liquid, the flow speed is set lower when the temperature control liquid is flown in the reverse direction RD in the warming mode than when the temperature control liquid is flown in the forward direction FD in the cooling mode.

With such a configuration, in the cooling mode, the driver ICs 213 can be promptly cooled with a large amount of liquid flow. In the warming mode, the temperature control liquid is heated with the driver IC 213 over time to increase the temperature of the temperature control liquid. Thus, liquid flowing through the liquid supply channel 203 can be effectively heated through the heat exchanger 206.

Such a configuration can warm the temperature control liquid without installing another heating unit.

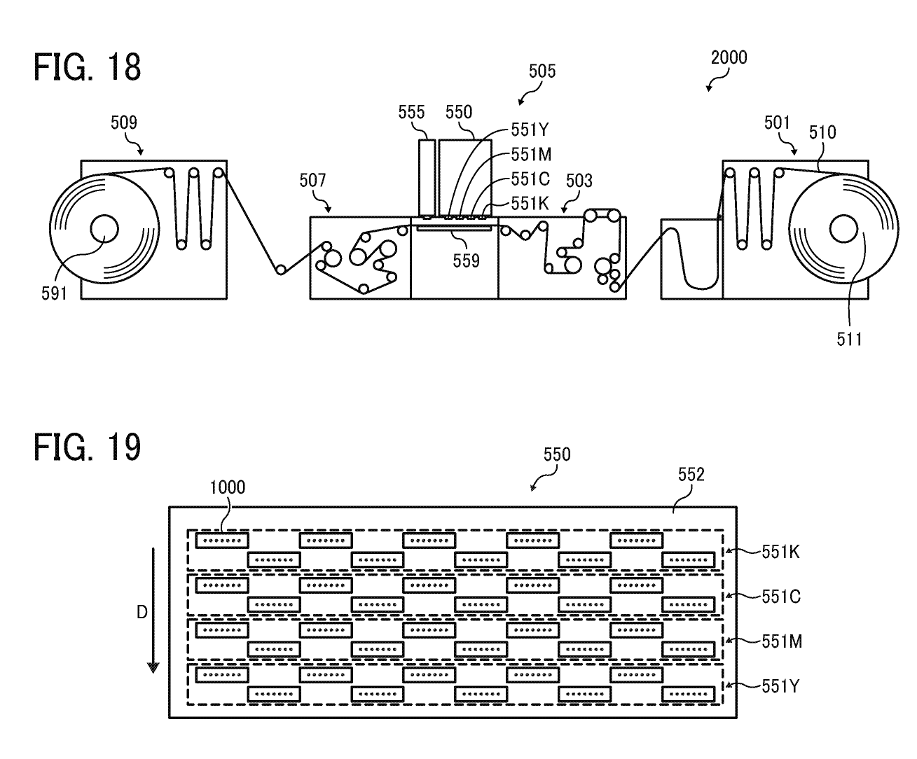

Next, a liquid discharge apparatus 2000 according to an embodiment of the present disclosure is described with reference to FIGS. 18 and 19. FIG. 18 is an illustration of the liquid discharge apparatus according to an embodiment of the present disclosure. FIG. 19 is a plan view of a head unit of the liquid discharge apparatus.

The liquid discharge apparatus 2000 according to the present embodiment includes a feeder 501 to feed a continuous medium 510, a guide conveyor 503 to guide and convey the continuous medium 510, fed from the feeder 501, to a printing unit 505, the printing unit 505 to discharge liquid onto the continuous medium 510 to form an image on the continuous medium 510, a drier unit 507 to dry the continuous medium 510, and an ejector 509 to eject the continuous medium 510.

The continuous medium 510 is fed from a root winding roller 511 of the feeder 501, guided and conveyed with rollers of the feeder 501, the guide conveyor 503, the drier unit 507, and the ejector 509, and wound around a winding roller 591 of the ejector 509.

In the printing unit 505, the continuous medium 510 is conveyed opposite a first head unit 550 and a second head unit 555 on a conveyance guide 559. The first head unit 550 discharges liquid to form an image on the continuous medium 510. Post-treatment is performed on the continuous medium 510 with treatment liquid discharged from the second head unit 555.

Here, the first head unit 550 includes, for example, four-color full-line head arrays 551K, 551C, 551M, and 551Y (hereinafter, collectively referred to as “head arrays 551” unless colors are distinguished) from an upstream side in a feed direction of the continuous medium 510 (hereinafter, “medium feed direction”) indicated by arrow D in FIG. 19.

The head arrays 551K, 551C, 551M, and 551Y are liquid dischargers to discharge liquid of black (K), cyan (C), magenta (M), and yellow (Y) onto the continuous medium 510. Note that the number and types of color are not limited to the above-described four colors of K, C, M, and Y and may be any other suitable number and types.

In each of the head arrays 551, for example, as illustrated in FIG. 19, a plurality of head devices 1000 according to an embodiment of the present disclosure, each including the circulation-type head body 211, is arranged in a staggered manner on a base member 552. However, the configuration of the head array 551 is not limited to such a configuration. Note that, in FIG. 19, the head device 1000 is illustrated in a simplified manner.

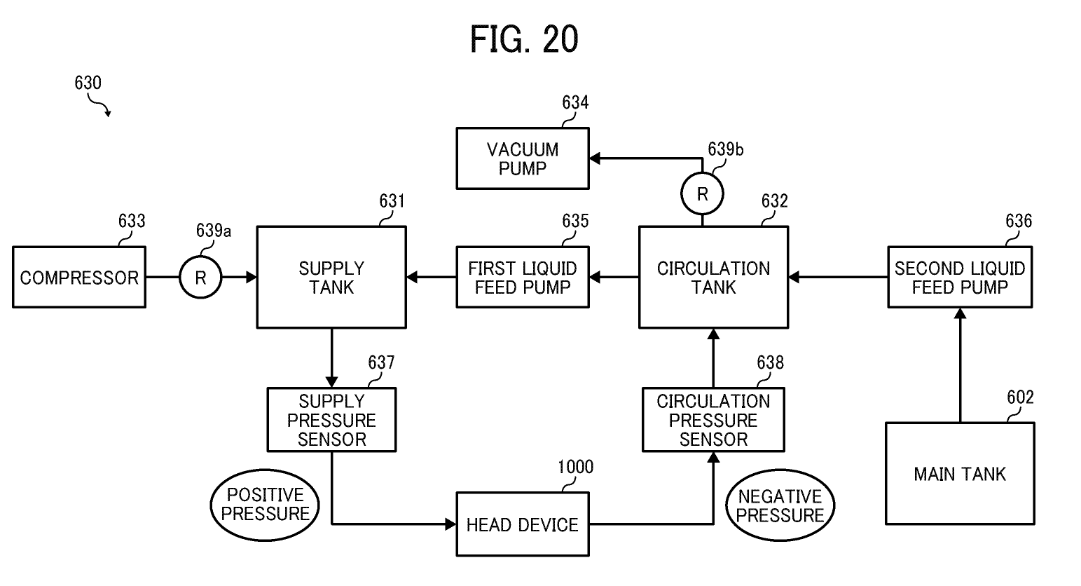

Next, an example of a liquid circulation system according to an embodiment of the present disclosure is described with reference to FIG. 20. FIG. 20 is a block diagram of the liquid circulation system according to an embodiment of the present disclosure.

A liquid circulation system 630 illustrated in FIG. 20 includes, e.g., a main tank 602, the head device 1000, a supply tank 631, a circulation tank 632, a compressor 633, a vacuum pump 634, a first liquid feed pump 635, a second liquid feed pump 636, a supply pressure sensor 637, a circulation pressure sensor 638, a regulator (R) 639a, and a regulator (R) 639b.

The supply pressure sensor 637 is disposed between the supply tank 631 and the head device 1000 and connected to a supply channel side connected to the supply ports 215 (see FIG. 11) of the head device 1000. The circulation pressure sensor 638 is disposed between the circulation tank 632 and the head device 1000 and connected to a supply channel side connected to the delivery ports 217 (see FIG. 11) of the head device 1000.

One end of the circulation tank 632 is connected to the supply tank 631 via the first liquid feed pump 635 and the other end of the circulation tank 632 is connected to the main tank 602 via the second liquid feed pump 636.

Thus, liquid is flown from the supply tank 631 into the head device 1000 through the supply ports 215 and output from the delivery ports (circulation ports) 217 to the circulation tank 632. Further, the first liquid feed pump 635 feeds liquid from the circulation tank 632 to the supply tank 631, thus circulating liquid.

The supply tank 631 is connected to the compressor 633 and controlled so that a predetermined positive pressure is detected with the supply pressure sensor 637. The circulation tank 632 is connected to the vacuum pump 634 and controlled so that a predetermined negative pressure is detected with the circulation pressure sensor 638.

Such a configuration allows the menisci of ink to be maintained at a constant negative pressure while circulating ink through the inside of the head device 1000.

When droplets are discharged from the nozzles 104 of the head device 1000, the amount of liquid in each of the supply tank 631 and the circulation tank 632 decreases. Hence, the second liquid feed pump 636 replenishes liquid from the main tank 602 to the circulation tank 632. The replenishment of liquid from the main tank 602 to the circulation tank 632 is controlled in accordance with a result of detection with, e.g., a liquid level sensor in the circulation tank 632, for example, in a manner in which liquid is replenished when the liquid level of liquid in the circulation tank 632 is lower than a predetermined height.

In each of the above-described embodiments, the example is described in which the temperature control liquid flowing through the first temperature-control-liquid channel is the same as the temperature control liquid flowing through the second temperature-control-liquid channel. However, in some embodiments, the temperature control liquid flowing through the first temperature-control-liquid channel may differ from the temperature control liquid flowing through the second temperature-control-liquid channel. In such a configuration, the first temperature-control-liquid channel is not connected to the second temperature-control-liquid channel.

In the above-described embodiments of the present disclosure, the liquid discharge apparatus includes a liquid discharge device and drives a liquid discharge head to discharge liquid. The liquid discharge apparatus may be an apparatus capable of discharging liquid to a material to which liquid can adhere and an apparatus to discharge liquid toward gas or into liquid.

The liquid discharge apparatus may include devices to feed, convey, and eject the material on which liquid can adhere. The liquid discharge apparatus may further include a pretreatment apparatus to coat a treatment liquid onto the material, and a post-treatment apparatus to coat a treatment liquid onto the material, onto which the liquid has been discharged.

The liquid discharge apparatus may be, for example, an image forming apparatus to form an image on a sheet by discharging ink, or a three-dimensional apparatus to discharge a molding liquid to a powder layer in which powder material is formed in layers, so as to form a three-dimensional article.

The liquid discharge apparatus is not limited to an apparatus to discharge liquid to visualize meaningful images, such as letters or figures. For example, the liquid discharge apparatus may be an apparatus to form meaningless images, such as meaningless patterns, or fabricate three-dimensional images.

The above-described term “material on which liquid can be adhered” represents a material on which liquid is at least temporarily adhered, a material on which liquid is adhered and fixed, or a material into which liquid is adhered to permeate. Examples of the “material on which liquid can be adhered” include recording media, such as paper sheet, recording paper, recording sheet of paper, film, and cloth, electronic component, such as electronic substrate and piezoelectric element, and media, such as powder layer, organ model, and testing cell. The “material on which liquid can be adhered” includes any material on which liquid is adhered, unless particularly limited.

Examples of the material on which liquid can be adhered include any materials on which liquid can be adhered even temporarily, such as paper, thread, fiber, fabric, leather, metal, plastic, glass, wood, and ceramic.

Examples of the liquid are, e.g., ink, treatment liquid, DNA sample, resist, pattern material, binder, mold liquid, or solution and dispersion liquid including amino acid, protein, or calcium.

The liquid discharge apparatus may be an apparatus to relatively move a liquid discharge head and a material on which liquid can be adhered. However, the liquid discharge apparatus is not limited to such an apparatus. For example, the liquid discharge apparatus may be a serial head apparatus that moves the liquid discharge head or a line head apparatus that does not move the liquid discharge head.

Examples of the liquid discharge apparatus further include a treatment liquid coating apparatus to discharge a treatment liquid to a sheet to coat the treatment liquid on the surface of the sheet to reform the sheet surface and an injection granulation apparatus in which a composition liquid including raw materials dispersed in a solution is injected through nozzles to granulate fine particles of the raw materials.

The pressure generator used in the liquid discharge head is not limited to a particular-type of pressure generator. The pressure generator is not limited to the piezoelectric actuator described in the above-described embodiments, and may be, for example, a thermal actuator that employs a thermoelectric conversion element, such as a thermal resistor or an electrostatic actuator including a diaphragm and opposed electrodes.

The terms “image formation”, “recording”, “printing”, “image printing”, and “molding” used herein may be used synonymously with each other.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. A head device comprising:
a liquid discharge head including a heat generation member;
a temperature-control-liquid channel disposed at a vicinity of the heat generation member, through which a temperature control liquid to cool the heat generation member flows;
a liquid supply channel to supply a liquid to the liquid discharge head; and
a thermal connector to thermally connect the temperature-control-liquid channel to the liquid supply channel at an upstream side from the heat generation member in a direction of flow of the temperature control liquid.

2. A liquid discharge apparatus comprising:
the head device according to claim 1;
a temperature regulator to control temperature of the temperature control liquid flowing into the head device; and
a control-liquid circulation channel to circulate the temperature control liquid between the head device and the temperature regulator.

3. The head device according to claim 1,
wherein the thermal connector is a metal block.

4. The head device according to claim 1,
wherein the thermal connector is a thermal conductive tape.

5. The head device according to claim 1,
wherein the liquid discharge head includes a piezoelectric actuator.

6. The head device according to claim 1,
wherein the liquid discharge head includes a driver integrated circuit.

7. A head device comprising:
a liquid discharge head including a piezoelectric actuator;
a temperature-control-liquid channel through which a temperature control liquid to cool the liquid discharge head flows;
a liquid supply channel to supply a liquid to the liquid discharge head; and
a thermal connector to thermally connect the temperature-control-liquid channel to the liquid supply channel at an upstream side from the liquid discharge head in a direction of flow of the temperature control liquid.

8. The head device according to claim 7,
wherein the liquid discharge head includes a driver integrated circuit.

9. A liquid discharge apparatus comprising:
the head device according to claim 7;
a temperature regulator to control temperature of the temperature control liquid flowing into the head device; and
a control-liquid circulation channel to circulate the temperature control liquid between the head device and the temperature regulator.

10. The head device according to claim 7,
wherein the thermal connector is a metal block.

11. The head device according to claim 7,
wherein the thermal connector is a thermal conductive tape.
